(19) United States
(12) Patent Application Publication
(10) Pub. No.: US 2024/0399178 A1
(43) Pub. Date: Dec. 5, 2024

(54) FACE MASK FOR FIRE EVACUATION

(71) Applicant: LS INNOVATION CO.,LTD., Ansan-si (KR)

(72) Inventor: Hyo Jin YOON, Ansan-si (KR)

(21) Appl. No.: 18/515,922

(22) Filed: Nov. 21, 2023

(30) Foreign Application Priority Data
May 30, 2023 (KR) 10-2023-0068907

(51) Int. Cl. A62B 18/02; A62B 7/10; A62B 18/08; A62B 19/00

(52) U.S. Cl. CPC A62B 18/02; A62B 7/10; A62B 18/082; A62B 19/00

(57) ABSTRACT

Described is a face mask for fire evacuation, in which a case for the purpose of exhaust is integrated with a filter part of a respiratory mask to block toxic gases generated in the event of fire, thereby improving the convenience in respiration of a wearer, and protecting the respiratory system during the occurrence of toxic gases due to fire. The face mask for fire evacuation includes a liquid receptacle in the case, which allows liquid to be discharged from the liquid receptacle and absorbed into a filter member as needed when wearing the mask, thereby more effectively blocking the inhalation of toxic gases and enhancing safety.

### CROSS-REFERENCE TO RELATED APPLICATION

This application is based on and claims priority of Korean Patent Application No. 10-2023-0068907, filed on May 30, 2023, in the Korean Intellectual Property Office, the disclosure of which is incorporated by reference herein in its entirety.

### BACKGROUND OF THE INVENTION

### Field of the Invention

The present invention relates to a face mask for fire evacuation, and more specifically, to a face mask for fire evacuation, in which a case for the purpose of exhaust is integrated with a filter part of a respiratory mask to block toxic gases generated in the event of fire, thereby improving the convenience in respiration of a wearer, and protecting the respiratory system during the occurrence of toxic gases due to fire.

Specifically, the present invention relates to a face mask for fire evacuation, which includes a liquid receptacle formed in the case such that, if necessary when the mask is worn, liquid is discharged from the liquid receptacle and is absorbed into a filter member, thereby more effectively blocking the inhalation of toxic gases and enhancing safety.

### Background Art

Toxic gases generated in case of fire, even in small amounts, can adversely affect a wearer's respiratory system and, in severe cases, can lead to death. Therefore, evacuees (wearers) wear masks to protect their respiratory system during fire evacuation.

Such a mask mainly includes a mask body for protecting the respiratory system and straps configured on both sides of the mask body. So, a wearer adjusts the length of the so that the mask body fits snugly on the wearer's face when worn.

However, in urgent situations like a fire, adjusting the straps of the mask can expose the wearer to danger for an extended time. If the wearer wears the mask without adjusting the straps the strings, depending on the wearer, the mask may not fit snugly on the face, necessitating holding the mask with a hand.

As described above, the wearer may have to evacuate while holding the mask with one hand, and it restricts actions since the wearer cannot freely use both hands. Accordingly, the wearer cannot evacuate rapidly or may be exposed to the danger of the surrounding environment, such as debris and structures resulting from the fire.

Furthermore, conventional masks for fire evacuation were provided in a dry mask form, which could be easily packaged and stored. So, the conventional masks cannot effectively block toxic gases, dust, and dirt accompanying a fire.

To overcome the above problems, products that store a wet-type mask for fire evacuation in packaging have been configured and sold. However, if a filter part of the mask is exposed to a wet state for a long time, since contamination can occur easily, wearers have to discard the wet masks and need to repurchase and store new products.

In addition, if a portion of a packaging material is damaged, the fluid in the wet mask stored in the packaging may be evaporated, so the mask cannot effectively block toxic gases, dust, dirt, etc.

### PATENT LITERATURE

### Patent Documents

Patent Document 1: Korean Patent No. 10-1865298 entitled ‘Life mask for fire evacuation’ (granted on May 31, 2018)

### SUMMARY OF THE INVENTION

Accordingly, the present invention has been made to solve the above-mentioned problems occurring in the prior arts, and it is an objective of the present invention to provide a face mask for fire evacuation, in which a case for the purpose of exhaust is integrated with a dry filter part of a respiratory mask to block toxic gases generated in the event of fire, thereby effectively protecting the respiratory system of a wearer and facilitating smooth breathing during the occurrence of toxic gases due to fire.

Specifically, an objective of the present invention is to provide a face mask for fire evacuation in which the dry filter part is configured to absorb a fluid and block the inhalation of toxic gases caused by fire, thereby effectively protecting the wearer's respiratory system.

To accomplish the above object, according to the present invention, there is provided a face mask for fire evacuation including: a facial part which includes a goggle mounting part provided on the upper side, a filter mounting part provided on the lower side, and first and second side parts provided on both sides; a goggle part which includes a goggle sheet and is coupled to the goggle mounting part to secure a frontal field of vision; a chin-tightening part which is provided on the inner side of the facial part and is configured to correspond to the position of a wearer's chin; and a filter part which is coupled to the filter mounting part of the facial part, and includes a filter member for filtering the wearer's inhalation and a one-way filter for exhausting the wearer's exhalation, wherein the first and second side parts are fastened to each other.

Moreover, the filter part includes: a front case having a receptacle fitting groove formed on the upper inner side and a front lattice member formed at the lower portion thereof; a rear case coupled to one side of the front case, and having a receptacle fitting groove formed on the upper inner side and a rear lattice member formed at the lower portion thereof; a filter member positioned between the receptacle fitting grooves and the front and rear lattice members of the front and rear cases; a one-way filter connected to the front and rear lattice members to exhaust the wearer's exhalation; a liquid receptacle assembled into the facing receptacle fitting grooves of the front and rear cases to discharge the liquid stored therein and absorb the liquid to the filter member.

Furthermore, the front and rear cases are configured such that horizontal guide grooves are respectively formed in the horizontal direction on surfaces facing each other along the upper and lower portions of the receptacle fitting grooves and are communicated with the receptacle fitting grooves through a plurality of vertical connection holes, such that the liquid moves horizontally along the horizontal guide grooves and is absorbed to the filter member.

Additionally, the horizontal guide grooves have liquid discharge holes continuously formed at regular intervals to communicate with the upper surfaces of the front and rear cases and the direction of the front and rear lattice members, such that the liquid discharged through the liquid discharge holes is absorbed to the filter member.

In addition, the horizontal guide grooves have liquid discharge holes formed in communication with the central direction of the front and rear lattice members, such that the liquid is concentratedly discharged towards the wearer's nose area and absorbed to the filter member.

Moreover, the front and rear cases are configured to have liquid discharge holes with a diameter smaller than that of the vertical connection holes provided between the receptacle fitting grooves and the horizontal guide grooves, such that the liquid entering the horizontal guide grooves through the vertical connection holes is discharged through the liquid discharge holes and moves horizontally along the horizontal guide grooves.

Furthermore, the liquid receptacle has a shape to be accommodated inside the receptacle fitting groove, and includes a cut tape which is formed longitudinally at one side to be connected with a pulling handle, such that when the wearer pulls the pulling handle, the cut tape is separated from the liquid receptacle and the liquid stored inside is discharged out.

Additionally, the liquid receptacle has a shape to be accommodated inside the receptacle fitting groove, a pulling handle is connected to one side thereof, and a slit pin pierces one side of the liquid receptacle moving when the wearer pulls the pulling handle in the direction of the slit pin provided on one side of the receptacle fitting groove, such that a tube is cut and the liquid stored inside is discharged out.

Moreover, the liquid receptacle has a shape to be accommodated inside the receptacle fitting groove, and includes a slit pin provided on one side of the receptacle fitting groove to be connected to a press button, such that when the wearer presses the push button, the slit pin pierces the one side of the liquid receptacle and the liquid stored inside is discharged out.

In addition, the one-way filter of the filter part includes front and rear cap bushings which are respectively formed to be extended to one side of a front cap assembled to the front lattice member and a rear cap assembled to the rear lattice member, which face each other, such that the rear cap bushing fits inside the front cap bushing penetrating a cap insertion hole of the filter member to communicate with each other.

The face mask for fire evacuation according to an embodiment of the present invention includes a one-way filter for the purpose of exhaust is integrated with a filter part of a respiratory mask to block toxic gases generated in the event of fire, thereby protecting the wearer's respiratory system and securing a clear front view during the occurrence of toxic gases due to fire.

In particular, the face mask for fire evacuation according to an embodiment of the present invention includes the liquid receptacle in the case, which allows liquid to be discharged from the liquid receptacle and absorbed into the filter member as needed when wearing the mask, thereby more effectively blocking the inhalation of toxic gases and enhancing safety.

Moreover, the face mask for fire evacuation according to an embodiment of the present invention includes the chin-tightening part configured in a dual structure for both children and adults so that wearers of all ages can wear it properly, thereby providing improved fit and safety for both adults and children.

Additionally, the face mask for fire evacuation according to an embodiment of the present invention allows a wearer to wear the mask by fastening both sides of the mask at the wearer's occipital region using Velcro tape, thereby minimizing time wasted in adjustment of the length of the straps to wear the mask, and facilitating quick wearing of the mask.

Furthermore, the face mask for fire evacuation according to an embodiment of the present invention includes the nose support extending horizontally between the nose and the eyes to prevent exhaled breath from moving upwards, thereby preventing the goggle part from fogging and ensuring clear visibility for activities.

In addition, the face mask for fire evacuation according to an embodiment of the present invention includes the film type goggle part having a corrugated structure, thereby minimizing the volume when stored. When a wearer wearing glasses wears the mask, the corrugated part is expanded to ensure a sufficient space therein. Accordingly, the wearer can wear the mask without removing the glasses, thus preventing degradation of the wearer's vision even after wearing the mask.

Therefore, the face mask for fire evacuation according to an embodiment of the present invention can improve reliability and competitiveness in the mask field, particularly in the fields of fire evacuation masks, flame-retardant masks, and face masks, as well as related and associated fields.

### BRIEF DESCRIPTION OF THE DRAWINGS

FIG. 1 is a perspective view roughly illustrating a wearing state of a face mask for fire evacuation according to the present invention.

FIG. 2 is a configurative diagram illustrating the front surface of the face mask for fire evacuation according to the present invention.

FIG. 3 is a configurative diagram illustrating the rear surface of the face mask for fire evacuation according to the present invention.

FIG. 4 is an exploded perspective view of a filter part of the present invention.

FIG. 5 is an exploded side view of the filter part of the present invention.

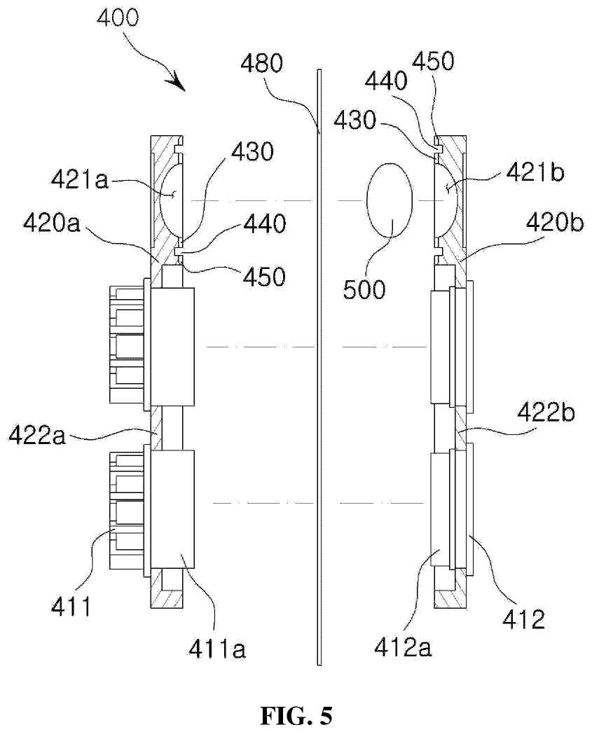

FIG. 6 is a sectional side view of the filter part of the present invention.

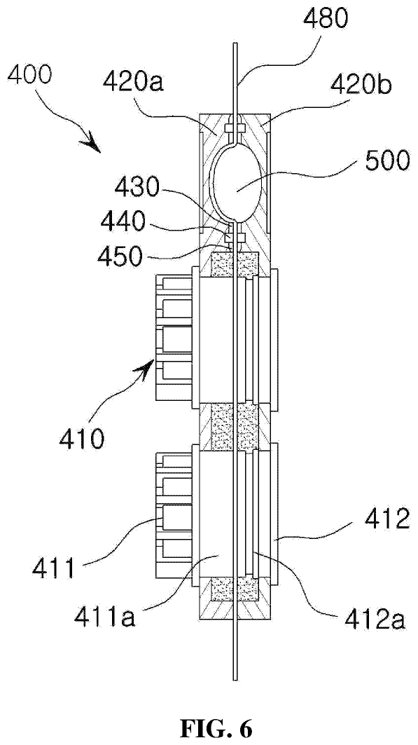

FIG. 7 is an enlarged view of essential parts of the filter part of the present invention.

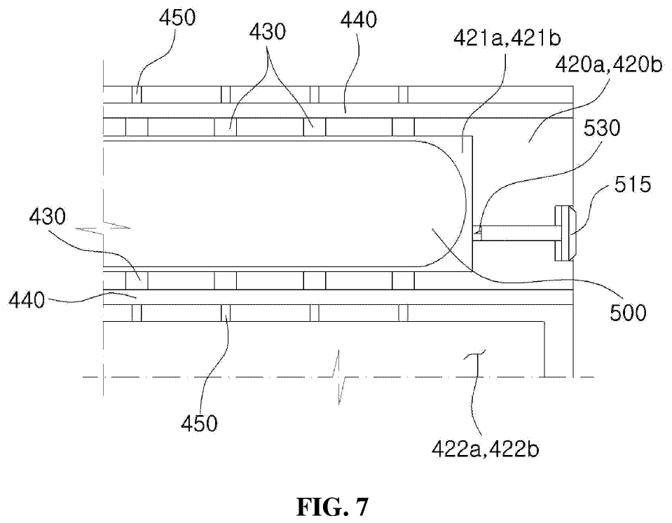

### DETAILED DESCRIPTION OF THE PREFERRED EMBODIMENT

Examples of a face mask for fire evacuation according to the present invention can be applied in various ways, and hereinafter, the most preferred embodiment will be described with reference to the accompanying drawings.

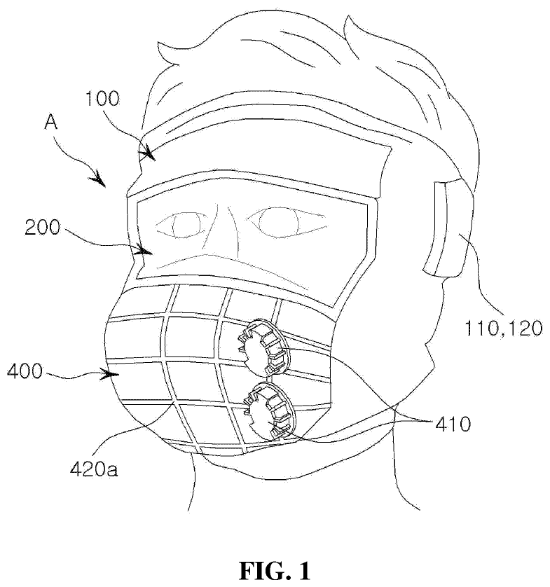

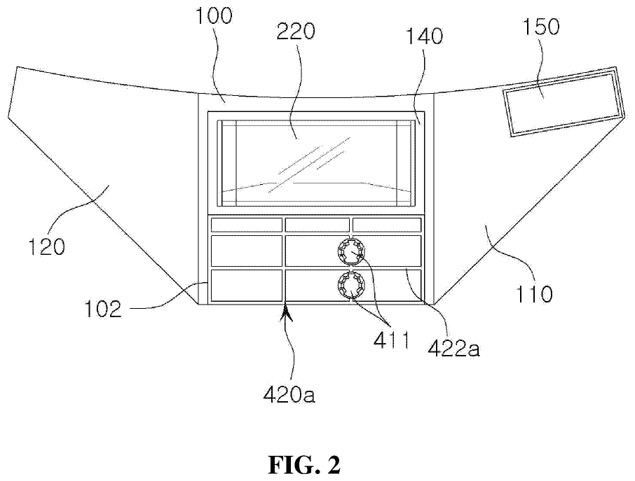

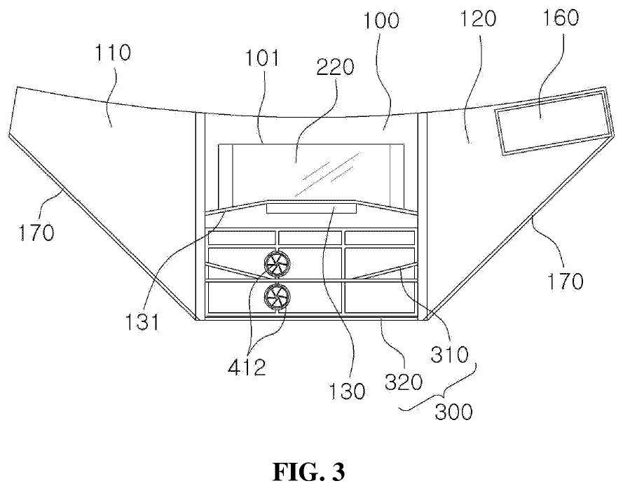

FIG. 1 is a perspective view roughly illustrating a wearing state of a face mask for fire evacuation according to the present invention, FIG. 2 is a configurative diagram illustrating the front surface of the face mask for fire evacuation according to the present invention, and FIG. 3 is a configurative diagram illustrating the rear surface of the face mask for fire evacuation according to the present invention.

Referring to FIG. 1, the face mask for fire evacuation A includes a facial part 100, a goggle part 200, a chin-tightening part 300, and a filter part 400.

The facial part 100 includes a goggle mounting part 101, on the upper front side of which the goggle part 200 is mounted, a filter mounting part 102, on the lower front side of which the filter part 400 is mounted, and first and second side parts 120 formed at both sides of the facial part 100.

Moreover, at least a portion of the first side part 110 may include a first fastening part 150, and at least a portion of the second side part 120 may include a second fastening part 160 at a position corresponding to the first fastening part 150.

Accordingly, the first and second side parts 120 can be worn to surround around from the head side to the occipital region of a wearer, and the first fastening part 150 and the second fastening part 160 respectively configured in the first and second side parts 120 can be fastened together at the wearer's occipital region.

For example, the first fastening part 150 and the second fastening part 160 can be composed of Velcro tape hooks and loops or snap buttons, etc.

When the first fastening part 150 and the second fastening part 160 are made with Velcro tape, both children and adults can wear the face mask in a one-touch manner easily and quickly while maintaining the state in which the upper portion is in tight contact with the head without the need for adjusting the length.

In addition, the first fastening part 150 and the second fastening part 160 can be connected to the chin-tightening part 300 with a banding line 170.

When the first fastening part 150 and the second fastening part 160 are coupled at the wearer's occipital region, the banding line 170 pulls both sides of the chin-tightening part 300, so that when the face mask for fire evacuation A is worn, they can fit tightly from the wearer's chin area to the occipital region through the roots of the ears.

Moreover, the first and second side parts 120 can be made of elastic nonwoven fabric to ensure a tight fit to the wearer's head.

Additionally, a nose support part 130 including a wire that can be deformed between the goggle mounting part 101 and the filter mounting part 102 can be configured.

Accordingly, during the process of wearing the fire evacuation face mask A of the present invention, the wearer can adjust the shape of the wire in the nose support part 130 to fit the face mask to the wearer's nasal bridge to prevent the inflow of harmful gases alongside the nose.

Moreover, the nose support part 130 can pass adjacent to the wire from the first side part 110, and then, a nasal bridge tightening part 131 can be formed to extend to the second side part 120. Here, the nasal bridge tightening part 131 can be a tightening strap made of an elastic material.

The nasal bridge tightening section 131 functions to pull both sides of the wire towards the sides and the back, thereby preventing the influx of harmful gases into the interior of the face mask A for fire evacuation in conjunction with the wire and preventing the wearer's exhaled breath from entering the goggle part 200 to prevent fogging on the goggle part 200.

Meanwhile, the face part 100 is manufactured from either elastic non-woven fabric or activated carbon filter member, and due to the characteristics of the material, there is difficulty in bonding with a goggle sheet 220 of polyimide material. In the present invention, a thermoplastic tape 140 can be utilized to bond the goggle sheet 220 to the face part 100. The thermoplastic tape 140 may include fiberglass tape.

The goggle mounting part 101 is formed on the upper side of the face part 100 to enable the wearer to secure a clear frontal view. The goggle part 200 of the polyimide material can be adhesively bonded by adhering the thermoplastic tape 140 along the periphery of the goggle mounting part 101, and the face part 100 made of elastic non-woven fabric or activated carbon filter member and the thermoplastic tape 140 are bonded by heat fusion, so that the goggle sheet 220 and the face part 100 can be coupled.

The goggle part 200 is designed to secure the wearer's frontal view, and can be formed from a transparent synthetic resin material in the form of a sheet. For instance, the material of the goggle part 200 can include polyimide (PI), which features excellent performance in heat resistance, impact resistance, abrasion resistance, flame retardancy, and dimensional stability.

Additionally, the chin-tightening part 300 is configured to correspond to the position of the wearer's chin when the face mask A is worn, and can be composed of a dual structure, which includes a child-specific chin-tightening part 310 designed to correspond to the chin position of a child and an adult-specific chin-tightening part 320 designed to correspond to the chin position of an adult.

In this instance, the child-specific chin-tightening part 310 and adult-specific chin-tightening part 320 may respectively include internal elastic tightening strings (not illustrated), considering that the central portion of the chin-tightening part 300 is pulled when the face mask A is worn, and may be configured to correspond to the average position from the nose support part 130 to the chin of children and the average position from the nose support part 130 to the chin of adults.

The filter part 400 is coupled to the filter mounting part 102 of the face part 100, such that a filter member 480 filters the inhalation of the wearer. The filter member 480 can be various types such as a HEPA filter, depending on the demands of those skilled in the art, and is not limited to any specific type.

In the filter member 480, cap insertion holes 481 are respectively formed inside of the child-specific chin-tightening part 310 and the adult-specific chin-tightening part 320 to communicate with the chin-tightening parts, and one-way filters 410 are respectively installed to exhaust the wearer's exhalation in one direction.

The one-way filter 410 is configured to be opened during the wearer's exhalation and closed during inhalation. The one-way filter 410 may be applied in various types according to demands of those skilled in the art, and are not limited to any specific type.

The present invention fixes the filter member 480 of the filter part 400 by a case, and allows liquid to be absorbed to the filter member 480 during evacuation to serve as a wet mask, thereby more effectively blocking the inhalation of toxic gases.

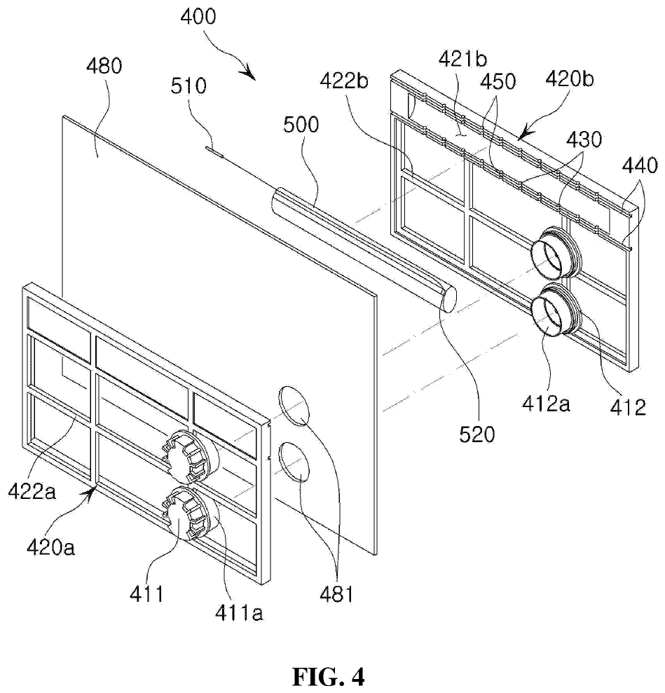

As illustrated in FIG. 4, the case of the filter part 400 is divided into a front case 420a and a rear case 420b, and the filter member 480 is arranged inside both the front and rear cases 420a and 420b, and a liquid receptacle 500 for storing the liquid at the upper portion thereof is assembled, so that the liquid discharged when the wearer cuts the liquid receptacle 500 is absorbed to the filter member 480.

The front case 420a and the rear case 420b respectively include semicircular receptacle fitting grooves 421a and 421b respectively formed on the facing upper inner sides, and front and rear lattice members 422a and 422b formed at lower portions thereof in a lattice shape.

Furthermore, the front and rear cases 420a and 420b are injection-molded of a soft silicone or synthetic resin material having properties such as heat resistance, impact resistance, abrasion resistance, flame retardancy, and dimensional stability, and is designed to allow easy deformation of the case shape in accordance with the wearer's facial shape. Horizontal guide grooves 440 are formed horizontally on the upper and lower portions of the receptacle fitting grooves 421a and 421b to communicate with the receptacle fitting grooves 421a and 421b through a plurality of vertical connection holes 430.

The horizontal guide grooves 440 are configured such that the liquid discharged from the liquid receptacle 500 flows through the receptacle fitting grooves 421a and 421b and the vertical connecting holes 430, and moves horizontally along the horizontal guide grooves 440 to allow the liquid to be absorbed evenly across the filter member 480 horizontally provided inside, thereby enabling rapid conversion into a wet mask in a disaster situation such as fire.

In addition, in the horizontal guide groove 440, liquid discharge holes 450 are continuously formed at regular intervals, which communicate with the upper surfaces of the front and rear cases 420a and 420b and the direction of the front and rear lattice members 422a and 422b, so that the liquid discharged through the horizontal guide grooves 440 and the liquid discharge holes 450 is quickly absorbed to the filter member 480.

Herein, the toxic gases inflow in the direction of the nose bridge and the goggle part during inhalation is further blocked while the liquid is absorbed to the filter member 480 through the horizontal guide grooves 440 and the liquid discharge holes 450 formed at the upper portions of the receptacle fitting grooves 421a and 421b, and the inhalation of toxic gases during inhalation is further blocked by the guide grooves 440 and the liquid discharge holes 450 formed at the lower portions of the receptacle fitting grooves 421a and 421b, thereby enhancing the safety of the respiratory system.

Moreover, in an embodiment of the present invention, the horizontal guide grooves 440 are formed only inside the front and rear cases 420a and 420b, and the liquid discharge holes 450 are formed only in the central direction of the front and rear lattice members 422a and 422b, namely, only at the center where the wearer's respiratory system is located, to communicate with the horizontal guide grooves 440, so that the liquid is discharged concentratedly towards the respiratory system of the wearer and absorbed to the filter member 480, thereby enabling quicker protection of the respiratory system.

In addition, the diameter of the liquid discharge holes 450 is formed to be smaller than that of the vertical connection holes 430 provided between the receptacle fitting grooves 421a and 421b and the horizontal guide grooves 440, such that the liquid flown into the horizontal guide groove 440 through the vertical connecting holes 430 is discharged in small amounts through the liquid discharge holes 450, thereby moving horizontally along the horizontal guide grooves 440 and converting the filter member 480 evenly into a wet mask overall.

The filter member 480 is arranged between the receptacle fitting grooves 421a and 421b and the front and rear lattice members 422a and 422b of the front case 420a and the rear case 420b. On one side, cap insertion holes 481 are respectively formed to communicate with the inside of the child-specific chin-tightening section 310 and the adult-specific chin-tightening part 320, and the one-way filters 410 are penetratingly assembled to exhaust the wearer's exhalation in one direction.

Furthermore, in the present invention, by the coupling of the front and rear cases 420a and 420b, a shielding member with flame-retardant and heat-resistant functions, which faces the front and rear surfaces of the filter member 480 within the internal space of the front and rear lattice members 422a and 422b, may be further provided to prevent the liquid of the filter member 480 from evaporating and becoming contaminated in disaster situations.

The one-way filter 410 includes front and rear cap bushings 411a and 412a which are protrudingly formed to be extended to one side of the front cap 411 assembled to the front lattice member 422a and the rear cap 412 assembled to the rear lattice member 422b, which face each other, such that the rear cap bushing 412a fits inside the front cap bushing 411a penetrating the cap insertion hole 481 of the filter member 480 to communicate with each other, so the one-way filter 410 and the filter member 480 communicate with each other. For instance, a protrusion groove is formed on the inner diameter of the front cap bushing 411a, and a locking protrusion is formed on the outer diameter of the rear cap bushing 412a. It is preferable that after assembling the front and rear cases 420a and 420b including the filter member 480, the one-way filters 410 are mutually assembled in an uneven form to exhaust the exhalation of the wearer.

In addition, the liquid receptacle 500 assembled into the receptacle fitting grooves 421a and 421b facing each other in the front case 420a and the rear case 420b accommodates a predetermined amount of liquid inside and assembled into the receptacle fitting grooves 421a and 421b. When the wearer puts on the mask, the wearer arbitrarily breaks the liquid receptacle 500 to release the contained liquid, then, the liquid is absorbed to the filter member 480.

As an example of breaking the liquid receptacle 500, the liquid receptacle 500 accommodated inside the receptacle fitting grooves 421a and 421b has a long cylindrical shape, and includes a pulling handle 510 and a cut tape 520 connected to the pulling handle 510, wherein the pulling handle 510 and the cut tape 520 are formed in the longitudinal direction. When the wearer pulls the pulling handle 510 drawn out of the case in any one direction of the horizontal direction and the longitudinal direction of the front and rear cases 420a and 420b, the cut tape 520 is separated from the liquid receptacle 500 such that the liquid stored in the liquid receptacle 500 is discharged out.

In other words, as an example, the liquid receptacle 500 stores the liquid within a cylindrical film shape to prevent evaporation and contamination of the liquid under normal circumstances. When the wearer wears the face mask, if necessary, the wearer pulls the pulling handle 510. Then, the cut tape provided on one side of the liquid receptacle 500 is separated while cutting one side of the liquid receptacle (for instance, a structure to separate a cut tape provided on one side of sausage) such that the liquid is discharged to the filter member 480 and the liquid receptacle 500 through the cut part.

Furthermore, as another embodiment of the liquid receptacle 500, the liquid receptacle 500 is molded from film or elastic rubber material to form a shape (for example, a tube) that accommodates liquid, and is stored inside the receptacle fitting grooves 421a and 421b.

The pulling handle 510 is formed on one side of the liquid receptacle 500 to be connected integrally with film or rubber material, and a slit pin 530 is provided at a recess portion formed on one side of the receptacle fitting grooves 421a and 421b not to protrude beyond the receptacle fitting grooves.

Therefore, when the wearer pulls the pulling handle 510 drawn out of the front and rear cases 420a and 420b to move the liquid receptacle 500 in the direction of the slit pin 530, one side of the liquid receptacle 500 protrudes and the film or the tube is cut by being pierced by the slit pin 530, so that the liquid stored therein is discharged.

In addition, as a further embodiment of the liquid receptacle 500, the liquid receptacle 500 is molded from film or elastic rubber material to form a shape (for example, a tube) that accommodates liquid, and is stored inside the receptacle fitting grooves 421a and 421b.

Moreover, a slit pin 530 is provided at a recess portion formed on one side of the receptacle fitting grooves 421a and 421b not to protrude beyond the receptacle fitting grooves, and a push button 515 is arranged on the front case 420a adjacent to the slit pin 530.

Therefore, when the wearer presses the push button 515 of the front case 420a molded with a soft material, the slit pin 530 pierces one side of the liquid receptacle 500 to cut one side of the film or tube, thereby discharging the liquid stored inside.

As described above, the face mask for fire evacuation according to the present invention has been described. It should be understood that those skilled in the art to which the present invention pertains could realize other specific forms of the invention without changing the technical idea or essential characteristics thereof.

Therefore, the embodiments described above should be considered in all respects as illustrative and not restrictive.

What is claimed is:

1. A face mask for fire evacuation comprising:
a facial part which includes a goggle mounting part provided on the upper side, a filter mounting part provided on the lower side, and first and second side parts provided on both sides;
a goggle part which includes a goggle sheet and is coupled to the goggle mounting part to secure a frontal field of vision;
a chin-tightening part which is provided on the inner side of the facial part and is configured to correspond to the position of a wearer's chin; and
a filter part which is coupled to the filter mounting part of the facial part, and includes a filter member for filtering the wearer's inhalation and a one-way filter for exhausting the wearer's exhalation,
wherein the first and second side parts are fastened to each other.

2. The face mask for fire evacuation according to claim 1, wherein the filter part comprises:
a front case having a receptacle fitting groove formed on the upper inner side and a front lattice member formed at the lower portion thereof;
a rear case coupled to one side of the front case, and having a receptacle fitting groove formed on the upper inner side and a rear lattice member formed at the lower portion thereof;
a filter member positioned between the receptacle fitting grooves and the front and rear lattice members of the front and rear cases;
a one-way filter connected to the front and rear lattice members to exhaust the wearer's exhalation;
a liquid receptacle assembled into the facing receptacle fitting grooves of the front and rear cases to discharge the liquid stored therein and absorb the liquid to the filter member.

3. The face mask for fire evacuation according to claim 2, wherein the front and rear cases are configured such that horizontal guide grooves are respectively formed in the horizontal direction on surfaces facing each other along the upper and lower portions of the receptacle fitting grooves and are communicated with the receptacle fitting grooves through a plurality of vertical connection holes, such that the liquid moves horizontally along the horizontal guide grooves and is absorbed to the filter member.

4. The face mask for fire evacuation according to claim 3, wherein the horizontal guide grooves have liquid discharge holes continuously formed at regular intervals to communicate with the upper surfaces of the front and rear cases and the direction of the front and rear lattice members, such that the liquid discharged through the liquid discharge holes is absorbed to the filter member.

5. The face mask for fire evacuation according to claim 3, wherein the horizontal guide grooves have liquid discharge holes formed in communication with the central direction of the front and rear lattice members, such that the liquid is concentratedly discharged towards the wearer's nose area and absorbed to the filter member.

6. The face mask for fire evacuation according to claim 3, wherein the front and rear cases are configured to have liquid discharge holes with a diameter smaller than that of the vertical connection holes provided between the receptacle fitting grooves and the horizontal guide grooves, such that the liquid entering the horizontal guide grooves through the vertical connection holes is discharged through the liquid discharge holes and moves horizontally along the horizontal guide grooves.

7. The face mask for fire evacuation according to claim 2, wherein the liquid receptacle has a shape to be accommodated inside the receptacle fitting groove, and includes a cut tape which is formed longitudinally at one side to be connected with a pulling handle, such that when the wearer pulls the pulling handle, the cut tape is separated from the liquid receptacle and the liquid stored inside is discharged out.

8. The face mask for fire evacuation according to claim 2, wherein the liquid receptacle has a shape to be accommodated inside the receptacle fitting groove, a pulling handle is connected to one side thereof, and a slit pin pierces one side of the liquid receptacle moving when the wearer pulls the pulling handle in the direction of the slit pin provided on one side of the receptacle fitting groove, such that a tube is cut and the liquid stored inside is discharged out.

9. The face mask for fire evacuation according to claim 2, wherein the liquid receptacle has a shape to be accommodated inside the receptacle fitting groove, and includes a slit pin provided on one side of the receptacle fitting groove to be connected to a press button, such that when the wearer presses the push button, the slit pin pierces the one side of the liquid receptacle and the liquid stored inside is discharged out.

10. The face mask for fire evacuation according to claim 2, wherein the one-way filter of the filter part includes front and rear cap bushings which are respectively formed to be extended to one side of a front cap assembled to the front lattice member and a rear cap assembled to the rear lattice member, which face each other, such that the rear cap bushing fits inside the front cap bushing penetrating a cap insertion hole of the filter member to communicate with each other.
